(19) United States
(12) Patent Application Publication
(10) Pub. No.: US 2014/0290587 A1
(43) Pub. Date: Oct. 2, 2014

(54) COMESTIBLE ANIMAL CHEW AND PLAY TOY

(71) Applicant: NESTEC SA, VEVEY (CH)

(72) Inventor: Dan K. Dixon, St. Louis, MO (US)

(73) Assignee: NESTEC SA, VEVEY (CH)

(21) Appl. No.: 14/345,088

(22) PCT Filed: Sep. 5, 2012
(86) PCT No.: PCT/US12/53731

§ 371 Date: Mar. 14, 2014

Related U.S. Application Data
(60) Provisional application No. 61/626,056, filed on Sep. 20, 2011.

(51) Int. Cl. A01K 11/00

(52) U.S. Cl. CPC A01K 15/026
USPC 119/709

(57) ABSTRACT

The invention provides a comestible animal chew and play toy having a unique shape that engages an animal in play before and during consumption. In one aspect, the invention provides a comestible animal chew and play toy made from an edible composition having a helical shape. The edible composition of the comestible animal chew and play toy can be an extruded pet food composition. The edible composition can further include a filling that can be co-extruded, with the edible composition and formed into a helical shape.

### CROSS REFERENCE TO RELATED APPLICATIONS

This application claims priority to U.S. Provisional Application Ser. No. 61/626056 filed Sep. 20, 2011, the disclosure of which is incorporated herein by this reference.

### BACKGROUND OF THE INVENTION

1. Field of the Invention

The invention relates generally to animal chews and animal toys and particularly to comestible animal chew and play toys having a unique shape that engages an animal in play before and during consumption.

2. Description of Related Art

Animal chew toys are designed to entertain the animal, combat animal boredom, prevent destructive animal chewing behavior, and provide an outlet for an animal's innate chewing instinct. Generally, animal chew toys are made from plastic or other material that cannot be eaten by the animal. Animals typically tire of non-edible animal chew toys after a short period and move on to other activities. At the same time, non-edible animal chew toys provide no nutritional value to the animal and are limited in providing a health benefit to the animal.

U.S. Pat. No.5,965,182 discloses an animal chew and play toy that dispenses food while it is played with by the animal. The animal chew and play toy is in the form of an elastic or flexible spherical animal toy having an interior space and a slit or narrow opening of elongated shape through to the interior space. The animal chew and play toy can contain any type of food that is sized to fit inside the toy. The slit or narrow opening widens into a hole when pressure is applied to the ends of the slit or narrow opening, allowing a treat, such as animal food, treat or odor producing substance, inside the toy to fall out. An animal can typically open the slit and occasionally gain access to items placed inside the toy by biting or squeezing the toy. U.S. Pat. No. 5,560,319 discloses a play toy for an animal that can be gripped by the animal's mouth. The toy has any of a number of regular and irregular shapes, including rectangles and squares, having a plurality of tabs or other members intended to be grasped by and held in the animal's mouth. The toy's configuration is non-rigid and pliable and the structure contains a filling that forms a soft pillow or cushion like structure from which the tabs or members extend. A covering holds the filling and forms the outside surface of the toy. The filling material is of a non-toxic, non-harmful nature, and will not injure the animal if ingested or inhaled. U.S. Pat. No. 7,976,884 discloses an edible animal chew made from hide. The edible animal chew is made of rehydrated hide folded about an inner fill via a positioning sheath. The edible animal chew primarily has the shape of an elongated shaft or a bone. These animal chew toys are adequate for their purpose. There is, however, a need for new animal chew toys having a unique shape that engages an animal in play before and during consumption.

### SUMMARY OF THE INVENTION

It is, therefore, an object of the present invention to provide a comestible animal chew and play toy having a unique shape that engages an animal in play before and during consumption.

It is a further object of the invention to promote the health or wellness of an animal using a comestible animal chew and play toy.

It is yet another object of the present invention to improve the quality of life of an animal using a comestible animal chew and play toy.

It is still another object of the present invention to extend the prime years of an animal's life using a comestible animal chew and play toy.

It is a further object of the invention to provide containers and packages including one or more a comestible animal chew and play toy having a unique shape that engages an animal in play before and during consumption.

It is yet another object of the present invention to provide methods of manufacturing a comestible animal chew and play toy having a unique shape that engages an animal in play before and during consumption in a container or package.

One or more of these or other objects are achieved by providing a comestible animal chew and play toy made from an edible composition having a helical shape. The edible composition of the comestible animal chew and play toy can be an extruded pet food composition. The edible composition can further include a filling that can be co-extruded with the edible composition and formed into a helical shape.

Other and further objects, features, and advantages of the present invention will be readily apparent to those skilled in the art.

### BRIEF DESCRIPTION OF THE DRAWINGS

FIG. 1 shows a side view of a comestible animal chew and play toy comprising an edible composition having a helical shape in an embodiment of the invention.

FIG. 2 shows a front view of a comestible animal chew and play toy comprising an edible composition having a helical shape in an embodiment of the invention.

FIG. 3 shows a cross-section view of a comestible animal chew and play toy comprising an edible composition having a helical shape in an embodiment of the invention.

### DETAILED DESCRIPTION OF THE INVENTION

### Definitions

The term “animal” means any animal that could enjoy or benefit from a comestible animal chew and play toy, including dogs and cats.

The term “single package” means that the components of a kit are physically associated in or with one or more containers and considered a unit for manufacture, distribution, sale, or use. Containers include, but are not limited to, bags, boxes, cartons, bottles, packages of any type or design or material, over-wrap, shrink-wrap, affixed components (e.g., stapled, adhered, or the like), or combinations thereof. A single package may be containers of individual components physically associated such that they are considered a unit for manufacture, distribution, sale, or use.

The term “virtual package” means that the components of a kit are associated by directions on one or more physical or virtual kit components instructing the user how to obtain the other components, e.g., a bag or other container containing one component and directions instructing the user to go to a website, contact a recorded message or a fax-back service, view a visual message, or contact a caregiver or instructor to obtain instructions on how to use the kit or safety or technical information about one or more components of a kit.

The term “quality of life” means the ability to enjoy normal life activities.

The term “health and/or wellness of an animal” means the complete physical, mental, and social well being of the animal, not merely the absence of disease or infirmity.

The term “extending the prime” means extending the number of years an animal lives a healthy life and not just extending the number of years an animal lives, e.g., an animal would be healthy in the prime of its life for a relatively longer time.

As used herein, ranges are used herein in shorthand, so as to avoid having to list and describe each and every value within the range. Any appropriate value within the range can be selected, where appropriate, as the upper value, lower value, or the terminus of the range.

As used herein, the singular form of a word includes the plural, and vice versa, unless the context clearly dictates otherwise. Thus, the references “a”, “an”, and “the” are generally inclusive of the plurals of the respective terms. For example, reference to “a compound” or “a method” includes a plurality of such “compounds” or “methods.” Similarly, the words “comprise”, “comprises”, and “comprising” are to be interpreted inclusively rather than exclusively. Likewise the terms “include”, “including” and “or” should all be construed to be inclusive, unless such a construction is clearly prohibited from the context.

The terms “comprising” or “including” are intended to include embodiments encompassed by the terms “consisting essentially of and “consisting of'. Similarly, the term “consisting essentially of” is intended to include embodiments encompassed by the term “consisting of”.

All percentages expressed herein are by weight of the total weight of a composition unless expressed otherwise. For example, an ingredient in an amount of 25% by weight means that the ingredient is 25% of the total weight of a composition. Thus, if the total weight of the composition is 100 grams, the actual amount of the ingredient corresponding to 25% by weight would be 25 grams.

The methods and compositions and other advances disclosed here are not limited to particular methodology, protocols, and reagents described herein because, as the skilled artisan will appreciate, they may vary. Further, the terminology used herein is for the purpose of describing particular embodiments only, and is not intended to, and does not, limit the scope of that which is disclosed or claimed.

Unless defined otherwise, all technical and scientific terms, terms of art, and acronyms used herein have the meanings commonly understood by one of ordinary skill in the art in the field(s) of the invention, or in the field(s) where the term is used. Although any compositions, methods, articles of manufacture, or other means or materials similar or equivalent to those described herein can be used in the practice of the present invention, the preferred compositions, methods, articles of manufacture, or other means or materials are described herein.

All patents, patent applications, publications, technical and/or scholarly articles, and other references cited or referred to herein are in their entirety incorporated herein by reference to the extent allowed by law. The discussion of those references is intended merely to summarize the assertions made therein. No admission is made that any such patents, patent applications, publications or references, or any portion thereof, are relevant, material, or prior art. The right to challenge the accuracy and pertinence of any assertion of such patents, patent applications, publications, and other references as relevant, material, or prior art is specifically reserved.

### The Invention

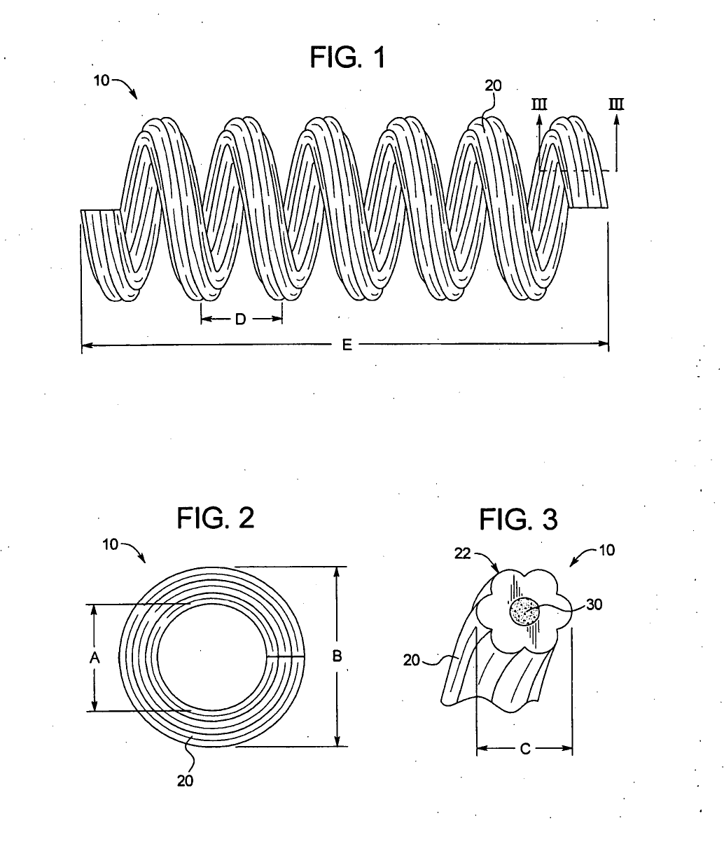

In one aspect shown in FIGS. 1-3, the invention provides a comestible animal chew and play toy 10 for engaging an animal in play before and during consumption. Comestible animal chew and play toy 10 comprises an edible composition 20 having a helical shape (e.g., coil shape). The invention is based upon the discovery that chews having a helical shape will induce an animal to play with the chew as well as consume the chew. While not bound by theory, it is believed that the spring-like action associated with the helical shape is playful and entertaining. Many other shapes do not induce such playful activity, even when the chew is made from the same ingredients.

The helical shape of comestible animal chew and play toy 10 has an internal diameter A and an external diameter B as shown in FIG. 2. Edible composition 20 of comestible animal chew and play toy 10 has a diameter C as shown in FIG. 3. A cross-sectional peripheral shape of comestible animal chew and play toy 10 can be in any form suitable for the toy, e.g., in the form of circle, a hexagon, a polygon, star, triangle, or a flower. The helical shape of comestible animal chew and play toy 10 has a pitch D and an overall length E shown in FIG. 3. Preferred values and ranges for A-E are shown in Table 1.

TABLE 1

| Parameters | Preferred Value | Acceptable Range |
|---|---|---|
| A:B | 1:2.25 | 1:2 to 1:14 |
| B:C | 1:4 | 1:2.5 to 1:28 |
| B:E | 1:2.25 | 1:1 to 1:10 |
| A:E | 1:5.1 | 1:1.75 to 1:20 |
| C:A | 1:1.75 | 1:0.5 to 1:10 |
| D (inches) | 0.3 | 0.01 to 1 |

The helical shape of comestible animal chew and play toy 10 can have any suitable length. Preferably, the overall length of the helical shape ranges from about 1 to about 20 inches. More preferably, the overall length of the helical shape ranges from about 2 to about 15 inches. Even more preferably, the overall length of the helical shape ranges from about 3 to about 10 inches or from about 5 to about 6 inches. The length of the helical shape can depend on the type and size of the animal's mouth that a particular comestible animal chew and play toy is designed for.

In addition, the die that forms the cross sectional shape of the rope can be stationary or can rotate. The rotation of the die increases the visual impact of the product by giving it a more interesting definition, especially as it is formed into a helical shape.

Although the overall helical shape of edible composition 20 provides it with unique properties, edible composition 20 can have any suitable cross-sectional peripheral shape 22. As shown in FIG. 3, edible composition 20 can have a cross-sectional peripheral shape in the form of a flower. Other examples of suitable cross-sectional peripheral shapes can be in the form of a circle, a hexagon, a polygon, star, triangle, or a flower.

Edible composition 20 can be made from any suitable ingredients. For example, edible composition 20 can include one or more edible ingredients such as meats, grains, starches, meat meals, proteins, fibers, sugars, vitamins, minerals, aromas, colors, flavors, oils, humectants, preservatives, or a combination thereof. Preferred starch sources can include crisp rice, ground rice, corn flour and the like.

In a further aspect as shown in FIG. 3, comestible animal chew and play toy 10 includes a filling 30. Filling 30 can extend partially or entirely through comestible animal chew and play toy 10. Filling 30 can be made from any suitable ingredients. For example, filling 30 can include one or more edible ingredients such as meats, grains, starches, meat meals, proteins, fibers, sugars, vitamins, minerals, aromas, colors, flavors, oils, humectants, preservatives, or a combination thereof.

In some embodiments, the comestible animal chew is made such that is could contain a filling 30 but the filling is not included in the comestible animal chew. This results in a chew and play toy 10 having a hollow core.

In other embodiments, the comestible animal chew is made such that is could contain a filling 30 but the filling is included in only one or more sections of the comestible animal chew, e.g., the filling is in the first one-half of the comestible animal chew. In one embodiment, the filling alternates in sections of the comestible animal chew, e.g., the filling fills one section, the next section has no filling, the next section has filling, the next section has no filling, and the like. The fillings can be regularly spaced or random. Having alternative sections of filling can increase the play associated with the toy since the animal searches for and anticipates the desirable filling.

The comestible animal chew can be made with or without a filling. Generally, the comestible animal chew has a filling that comprises from about 0 to about 50% filling, preferably from about 0 to about 40%, more preferably from about 0 to about 30%.

The comestible animal chew and play toy can be made from various ingredients using various methods known to skilled artisans. In a preferred embodiment, the comestible animal chew and play toy comprises a product comprising a coherent bio-plastics mass that includes a melted constituent, the melted constituent having included expanded material, as disclosed in US20060292288A1 and EP1440622A1. In another preferred embodiment, the comestible animal chew and play toy comprises an edible composition comprising at least one pre-activated, vegetable starch source and at least one bridger as disclosed in US20100034925A1 and EP1983841A1. In other embodiments, the comestible animal chew and play toy comprises a product made using the ingredients and methods disclosed in one of US20040086616A1, US20040197455A1, and US20050214349A1. Many such compositions are known to skilled artisans.

In another aspect, the invention provides methods for making a comestible animal chew and play toy suitable for engaging an animal in play before and during consumption. The methods comprise extruding an edible composition and forming the extruded edible composition into a helical shape. Any suitable device such as a coiling device can be used for shaping the extruded edible composition. The method can also comprise co-extruding a filling inside the edible composition and forming the co-extruded edible composition into a helical shape using a suitable shaping device.

In an alternative aspect, the invention provides methods for promoting the health or wellness of an animal. The methods comprise administering to an animal a health or wellness promoting amount of a comestible animal chew and play toy comprising an edible composition having a helical shape. Playing with, chewing, and consuming one or more of the comestible animal chew and play toys can help promote the health or wellness of the animal by providing activity and nutrition to the animal.

In another aspect, the invention provides methods for improving the quality of life of an animal. The methods comprise administering to an animal a quality of life improving amount of a comestible animal chew and play toy comprising an edible composition having a helical shape. Playing with, chewing, and consuming one or more of the comestible animal chew and play toys can help improve the quality of life of the animal by providing activity and nutrition to the animal.

In another aspect, the invention provides method for extending the prime years of an animal's life. The methods comprise administering to an animal a comestible animal chew and play toy comprising an edible composition having a helical shape in an amount effective for extending the prime years of the animal. Playing with, chewing, and consuming one or more of the comestible animal chew and play toys can help extend the prime years of the animal by providing activity and nutrition to the animal.

In an alternative aspect, the invention provides kits comprising in a single package or in separate containers in a virtual package, as appropriate for a kit component, (A) a comestible animal chew and play toy comprising an edible composition having a helical shape, and (B) one or more of: (1) a description of the benefits of the comestible animal chew and play toy; (2) instructions for how to administer the comestible animal chew and play toy; (3) a second edible composition; (4) a serving tray for serving the comestible animal chew and play toy; (5) a serving utensil for serving the comestible animal chew and play toy; (6) instructions for how to extend the prime years of an animal's life using the comestible animal chew and play toy; or (7) a non-edible animal chew toy.

When the kits comprise a virtual package, the kits can be limited to instructions in a virtual environment in combination with one or more physical kit components. The kits may contain the kit components in any of various combinations and/or mixtures. For example, in one embodiment, the kit includes a comestible animal chew and play toy described herein and instructions for how to administer the comestible animal chew and play toy. In another embodiment, the kit includes a comestible animal chew and play toy described herein and a non-edible animal chew toy.

In another aspect, the invention provides a means for communicating information about or instructions for a comestible animal chew and play toy comprising an edible composition having a helical shape for one or more of: (1) administering the comestible animal chew and play toy; (2) describing the benefits of comestible animal chew and play toy; (3) promoting the health or wellness of an animal with the comestible animal chew and play toy; or (4) extending the prime years of an animal's life with the comestible animal chew and play toy.

The communication means can be a document, digital storage media, optical storage media, audio presentation, or visual display containing the information or instructions. More specifically, the means can be a displayed website, a visual display kiosk, a brochure, a product label, a package insert, an advertisement, a handout, a public announcement, an audiotape, a videotape, a DVD, a CD-ROM, a computer readable chip, a computer readable card, a computer readable disk, a USB device, a FireWire device, a computer memory, or any combination thereof.

In another aspect, the invention provides packages comprising indicia describing a comestible animal chew and play toy comprising an edible composition having a helical shape. The indicia can be in the form of words, symbols, pictures, photographs, figures, or combinations thereof to show details or examples of the comestible animal chew and play toy comprising an edible composition having a helical shape described herein. The packages can further contain a comestible animal chew and play toy comprising an edible composition having a helical shape.

In an alternative aspect, the invention provides methods for manufacturing a container including a comestible animal chew and play toy comprising providing an extrudable edible composition, extruding the edible composition, forming the extruded edible composition into a helical shape, cutting the edible composition having the helical shape into discrete pieces to form the comestible animal chew and play toy, and filling the container with the pieces of the comestible animal chew and play toy. The manufacturing methods can further comprise retorting the container.

Alternatively, the manufacturing methods can comprise co-extruding the edible composition with a filling, forming the co-extruded edible composition into a helical shape, cutting the co-extruded edible composition having the helical shape into discrete pieces to form the comestible animal chew and play toy, and filling the container with the comestible animal chew and play toy. The edible composition and filling can be made from any suitable ingredients and have any suitable textural properties for making a helical shape.

In a further aspect, the invention provides continuous production lines capable of manufacturing a container comprising a comestible animal chew and play toy comprising an edible composition having a helical shape. More specifically, the continuous production lines can include various devices for making a container having the comestible animal chew and play toy comprising an edible composition having a helical shape. For example, the continuous production line can include a mechanical mixer for combining the ingredients of the edible composition and/or filling. The continuous production line can include an extruder/co-extruder for co-extruding the edible composition and the filling and a coiling device for shaping the co-extruded edible composition into a helical shape. The helical shaped co-extruded edible composition can be cut into discrete pieces to form the comestible animal chew and play toy and filled in a container. The filled container can then be sealed or closed and taken to a steamer/retorting station. A conveyor belt can -be used to transport the containers from one station to another station of the continuous production line. Continuous production lines, their components, and methods for constructing such lines are known to skilled artisans.

In an alternative aspect, the invention provides multi-pack packages comprising 1) a plurality of containers arranged in an array, each of the plurality of containers comprising a comestible animal chew and play toy comprising an edible composition having a helical shape, and 2) one or more devices for retaining the containers in the array. In various embodiments, the devices are boxes made from paper, plastic, polymers, or a combination thereof. In others, the devices are systems of connected plastic rings affixed to each of the containers. In still others, the devices are wrappings of plastic of similar materials, e.g., twelve cans stacked in an array and wrapped in plastic. In some embodiments, the multi-pack packages have one or more handles affixed to the multi-pack packages to facilitate handling and transporting the multi-pack packages.

In other embodiments, the devices further comprise one or more windows that permit the package contents to be viewed without opening the multi-pack package. In some embodiments, the windows are a transparent portion of the devices. In others, the windows are missing portions of the devices that permit the containers to be viewed without opening the multi-pack package.

In preferred embodiments, the multi-pack packages further comprise one or more indicia describing the contents of the containers in the packages. The indicia can be in the form of labels, printing on the packages, stickers, and the like and include words, symbols, pictures, photographs, figures, or combinations thereof to provide detail or examples of the comestible animal chew and play toy comprising an edible composition having a helical shape described herein. In a preferred embodiment, a label is affixed to the multi-pack packages containing a word or words, picture, design, acronym, slogan, phrase, or other device, or combination thereof, that indicates that the contents of the package contain a comestible animal chew and play toy comprising an edible composition having a helical shape.

### EXAMPLES

The invention can be further illustrated by the following examples, although it will be understood that these examples are included merely for purposes of illustration and are not intended to limit the scope of the invention unless otherwise specifically indicated.

### Play Testing Method

Helical shaped chews were tested with respect to consumption and play as follows. Dogs were fed their main meals in the mornings and then offered a treat (i.e., helical shaped chew) in the afternoon. Each dog was offered one treat. During the test the dogs were observed for their interaction with the treat. For each dog, treat acceptance (whether they ate some, all, or none of the treat), the time it took to consume the treat, and play behavior were scored. Play was defined as any behavior towards the treat that did not include eating the treat or holding the treat to consume it. Examples of play behaviors observed included rolling the treat with either the front paws or nose, throwing the treat in the air and running around the kennel with the treat in mouth.

### Example 1

The ingredients for the edible composition were used and processed as follows. The dry ingredients listed in Table 2 below were mixed together. This mix was then ground through a 4/64″ hammer mill screen to reduce the particle size for better extrusion. The ground mix and liquids listed in Table 2 were metered into an extruder to cook the mix. A vacuum stuffer attached to the extruder barrel just prior to its exit was used to de-gas the extrudate. The vacuum ranged from 10 to 17 (inches Hg) to produce the desired compact texture. The extruder barrel temperature was maintained at 140 to 145° F. (60 to 63° C.). The exit product temperature ranged from 195 to 225 F.° (91 to 107° C.). The gear box pressure was maintained in the range of 80 to 110 bars.

TABLE 2
Edible Composition Formulation

| | Ingredients | Weight (lbs) | Formula (%) |
|---|---|---|---|
| DRY | Crisp Rice | 72.2701 | 68.6566 |
| | Distilled Monoglyceride | 1.1618 | 1.1037 |
| | Caramel color | 0.0022 | 0.0021 |
| | BHA/BHT Powder | .0186 | 0.0177 |
| | Yeast | 2.3235 | 2.2073 |
| | Corn Germ Meal | 0.9294 | 0.8829 |
| | Dye Yellow #5 | 0.0023 | 0.0022 |
| | Sorbic Acid | 0.2556 | 0.2428 |
| | Titanium Dioxide | .4865 | 0.4622 |
| LIQUIDS | Glycerin | 12.5 | 11.875 |
| | Liquid Smoke Flavor | 0.05 | 0.0475 |
| | Water | 10.0 | 9.5 |
| | Total | 100.00 | 95.00 |

Instead of adding colors in the dry mix as shown in this example, color may be added via continuous color injection at the extruder to completely color the edible composition or by pulsed color injection for variation in color to the edible composition.

For the process described in this example, the range of conditions may be widened as follows: i) a vacuum stuffer can be used to de-gas the extrudate with 0 to 30 (inches Hg), with the more preferred vacuum range being 7 to 25 (inches Hg) and the most preferred vacuum range being from 10 to 17 (inches Hg) for most desirable texture; ii) the extruder barrel temperatures can be maintained at 120 to 160° F. (49 to 71° C.), with more preferred range being 130 to 150° F. (54 to 66° C.) and the most preferred temperature range being from 140 to 145° F. (60 to 63° C.) for optimal processing conditions; iii) the exit product temperature can range from 185 to 235° F. (85 to 113° C.), with the more preferred range being 195 to 225° F. (91 to 107° C.) and the most preferred temperature range being from 200 to 220° F. (93 to 104° C.); and iv) the gear box pressure can range from 60 to 135 bars, with the more preferred range being from 70 to 125 bars ‘ and the most preferred range being from 80 to 110 bars.

In a separate operation, the filling was prepared by adding the dry and liquid ingredients per the filling formulation in Table 3 below to a batch mixer with mixing arms (paddles). While continuously agitating, the mixer was heated with steam to cook the filling to 185 to 195° F. (85 to 91° C.) and transformed it into a visco-elastic dough. This heated dough was placed in a hopper connected to a high pressure pump.

TABLE 3
Filling Formula

| | Ingredients | Weight (lbs) | Formula (%) |
|---|---|---|---|
| DRY | Animal Digest | 3.7542 | 0.1877 |
| | Gelatin 250 bloom | 1.609 | 0.0805 |
| | Deoiled (dry) Soy | 0.1006 | 0.005 |
| | Lecithin | | |
| | Sugar | 6.4694 | 0.3235 |
| | Wheat Gluten | 2.6146 | 0.1307 |
| | Wheat Flour | 38.9435 | 1.9472 |
| | Poultry By-Product Meal | 11.2627 | 0.5631 |
| | Salt | 1.8771 | 0.0939 |
| | Sorbic Acid | 0.4089 | 0.0204 |
| | Color Blend | 0.0081 | 0.0004 |
| LIQUIDS | Beef Flavor | 0.2757 | 0.0138 |
| | Hydrogenated Starch | 9.5023 | 0.4751 |
| | Hydrolysates | | |
| | Phosphoric acid | 2.0504 | 0.1025 |
| | Glycerin | 5.4016 | 0.2701 |
| | Tallow | 6.35 | .3175 |
| | Water | 9.3719 | 0.4686 |
| | Total | 100 | 5.00 |

The extruder-cooked edible composition formulation was fed to a co-extrusion die to form a hollow cylindrical rope of 0.5 inch diameter. The filling formulation was metered and fed into the center of the edible composition at the co-extrusion die using a high pressure pump and hose connected to the co-extrusion die. The filling rate was 5% of the total product mass (Table 4).

TABLE 4
Finished Formula

| Ingredients | Weight (lbs) | Formula (%) |
|---|---|---|
| Edible composition | 95 | 95 |
| Filling | 5 | 5 |
| Total | 100 | 100 |

The co-extruded rope was cut into pieces of length of between 29 to 30 inches weighing about 100 to 110 grams. Each rope was transferred while still hot to a coiling device to form the helical shaped chews. The coiling device created a helical shaped chew that had a 1 inch internal diameter (I.D.) with coil spacing (i.e., pitch) of 0.375 inch for an overall length of 4.7 inches. The portion of the coiling device that held the helical shaped chew was sent through a cooling conveyor to set the product before discharging the helical shaped chew product onto a conveyor for packaging. 9% shrinkage of the rope dimensions was observed after a week. No further shrinkage occurred after that.

The helical shaped chew pieces were tested for play using a panel of 20 small to medium dogs. The results are shown in Table 5. A discussion of Table 5 is provided by the examples that follow. Referring to the results, it is seen that 5 of the 20 dogs played with the chews while eating.

TABLE 5

| | | Helical | | Helical | | | | |
|---|---|---|---|---|---|---|---|---|
| | | Shaped | | Shaped | Rope | | | |
| | Rope | Chew | | Chew | Profile | | Number | Time for |
| | Diameter | ID | Weight | Length | or | Dog | Dogs | Consumption |
| Example | (inch) | (inch) | (Gms) | (inch) | Shape | Size | Playing | (Minutes) |
| 1 | 0.5 | 1 | 100 | 4.7 | Round | Small | 5 | 10.8 |
| | | | | | | to | | |
| | | | | | | medium | | |
| 2 | 0.5 | 1 | 200 | 7 | Round | Large | 6 | 9.6 |
| 2 | 0.5 | 2 | 200 | 3.5 | Round | Large | 2 | 10.2 |
| 3 | 0.375 | 0.75 | 100 | 5 | Round | Small | 4 | 9.6 |
| | | | | | | to | | |
| | | | | | | medium | | |
| 4 | 0.375 | 0.75 | 100 | 5 | Round | Small | 1 | 7.2 |
| | | | | | | to | | |
| | | | | | | medium | | |
| 4 | 0.375 | 0.75 | 100 | 5 | Round | Large | 1 | 3.7 |
| 4 | 0.5 | 1 | 100 | 4.7 | Round | Small | 13 | 8.8 |
| | | | | | | to | | |
| | | | | | | medium | | |
| 4 | 0.5 | 1 | 100 | 4.7 | Round | Large | 6 | 4.6 |
| 6 | 0.4375 | 1 | 100 | 5.25 | Flower | Small | 4 | 6.09 |
| | | | | | | to | | |
| | | | | | | medium | | |
| 6 | 0.4375 | 1 | 100 | 5.25 | Flower | Large | 3 | 3.49 |
| 6 | 0.5625 | 1 | 100 | 5.1 | Flower | Small | 1 | 8.21 |
| | | | | | | to | | |
| | | | | | | medium | | |
| 6 | 0.5625 | 1 | 100 | 5.1 | Flower | Large | 9 | 4.46 |
| 7 | — | — | 100 | — | Ball | Small | 2 | 9.09 |
| | | | | | | to | | |
| | | | | | | medium | | |
| 7 | — | — | 100 | — | Ball | Large | 0 | 5.49 |
| 8 | — | — | 100 | — | Stick | Small | 0 | 9.3 |
| | | | | | | to | | |
| | | | | | | medium | | |
| 8 | — | — | 100 | — | Stick | Large | 4 | 5.17 |
| 9 | — | — | 100 | 5.1 | Bone | Small | 0 | 11.9 |
| | | | | | | to | | |
| | | | | | | medium | | |
| 9 | — | — | 100 | 5.1 | Bone | Large | 1 | 5.4 |

### Example 2

Helical shaped chews were made as in example 1 except for two larger piece size variations. Using 200 grams of co-extrudate (1) a set of helical shaped chews of length 7 inches were formed; and (2) a second set of helical shaped chews of internal diameter of 2 inches were made. These two sets of helical shaped chews were offered separately to panels of 20 large breed dogs and the results of play are shown in Table 5. It is seen that 6 dogs played with the helical shaped chews of 1 inch internal diameter before consuming.

### Example 3

Helical shaped chews were made as in example 1 except the diameter of the die opening was reduced to produce ropes of 0.375 inch diameter and the internal diameter was reduced to 0.75 inch. The,helical shaped chew length was now 5 inches. These were offered to panels of 20 small to medium or 20 large breed dogs per the method above. The results for play are shown in Table 5. Referring to the data, it is seen that when the pieces were consumed faster, there was less play.

### Example 4

Helical shaped chews were made as in example 1 except that there was no co-extruded filling but a solid rope with the edible composition formulation. Two sizes of helical shaped chews were made. One set with rope diameter 0.5 inch and internal diameter ‘1 inch as in example 1. A second set as in example 3 with ropes of 0.375 inch diameter and the internal diameter of 0.75 inch. Each set was offered to separately to panels of 20 large or 20 small to medium dogs. The results are shown in Table 5. It is seen that there was significant play by both large (6 of 20) and small to medium (13 of 20) dogs with the larger 0.5 inch diameter helical shaped chews.

### Example 5

Chews were made as in example 1 except that the round cross-section profile of the rope was changed to a star, a flower, or a triangle with longest cross-sectional measure being 0.5 inch. Helical shaped chews with each of these profiles were presented to a consumer focus group. The flower was chosen as the most appealing and was used for play testing.

### Example 6

Two sets of center-filled helical shaped chews with a flower shape were made as in examples 1 and 5. One set had rope cross-section of 0.4375 inch and the second set has a rope cross-section of 0.5625 inch. For these, prior to coiling, the rope was rotated in the die to form a twisted rope. Then the twisted ropes for both sets were helical shaped to an internal diameter of 1 inch. Each set of helical shaped chews were offered to panels of 20 large and 20 small to medium dogs. The results are shown in Table 5. It is seen that there was significant play (9 of 20) with the helical shaped chews of 0.5625 in by the larger dogs. The small to medium dogs played more with the 0.4375 inch helical shaped chews.

### Example 7

The 0.5625 inch diameter ropes of example 6 were cut into 30 inch long pieces and while still hot were rolled into ball (spherical) shapes. These were offered to panels of 20 large or 20 small to medium dogs as per the play testing method. The results are shown in Table 5. As can be seen there was no play by the large dogs and 2 small to medium dogs played with the ball.

### Example 8

The 0.5625 inch diameter ropes of example 6 were cut into 30 inch long pieces and while still hot were formed into stick shapes by folding the rope back on itself in 5 inch increments. Due to the folding, there was some springiness. These were offered to panels of 20 large or 20 small to medium dogs as per the play testing method. The results are shown in Table 5. As can be seen there was play by 4 of the large dogs and but no small to medium dog played.

### Example 9

A commercial chew treat, Purina Busy Bone® with composition and filling similar to the helical shaped treats was also tested for play using to panels of 20 large or 20 small to medium dogs. The results are shown in Table 5. As can be seen no small to medium dog played with the treat and only 1 large dog played.

In the specification, there have been disclosed typical preferred embodiments of the invention. Although specific terms are employed, they are used in a generic and descriptive sense only and not for purposes of limitation. The scope of the invention is set forth in the claims. Obviously many modifications and variations of the invention are possible in light of the above teachings. It is therefore to be understood that within the scope of the appended claims the invention may be practiced otherwise than as specifically described.

What is claimed is:

1. A comestible animal chew and play toy suitable for engaging an animal in play before and during consumption comprising an edible composition having a helical shape.

2. The comestible animal chew and play toy of claim 1 wherein a ratio of an internal diameter of the helical shape to an external diameter of the helical shape ranges from 1:2 to 1:14.

3. The comestible animal chew and play toy of claim 1 wherein a ratio of an external diameter of the helical shape to a diameter of the edible composition ranges from 1:2.5 to 1:28.

4. The comestible animal chew and play toy of claim 1 wherein a ratio of an external diameter of the helical shape to a pitch of the helical shape ranges from 1:1 to 1:10.

5. The comestible animal chew and play toy of claim 1 wherein a ratio of an internal diameter of the helical shape to a pitch of the helical shape ranges from 1:1.75 to 1:20.

6. The comestible animal chew and play toy of claim 1 wherein a ratio of a diameter of the edible composition to an internal diameter of the helical shape ranges from 1:0.5 to 1:10.

7. The comestible animal chew and play toy of claim 1 wherein the helical shape has a pitch ranging from about 0.01 to about 1 inch.

8. The comestible animal chew and play toy of claim 1 wherein the helical shape has an overall length ranging from about 1 to about 20 inches.

9. The comestible animal chew and play toy of claim 1 wherein the edible composition comprises a cross-sectional peripheral shape in the form of a circle, a hexagon, a polygon, star, triangle, or a flower.

10. The comestible animal chew and play toy of claim 1 wherein the edible composition includes one or more edible ingredients selected from the group consisting of meats, grains, starches, meat meals, proteins, fibers, sugars, vitamins, minerals, aromas, colors, flavors, oils, humectants, preservatives, and combinations thereof.

11. The comestible animal chew and play toy of claim 1 wherein the edible composition comprises a filling.

12. The comestible animal chew and play toy of claim 11 wherein the filling includes one or more edible ingredients selected from the group consisting of meats, grains, starches, meat meals, proteins, fibers, sugars, vitamins, minerals, aromas, colors, flavors, oils, humectants, preservatives, and combinations thereof.

13. The comestible animal chew and play toy of claim 1 wherein the edible composition is an extruded pet food composition.

14. A method for making a comestible animal chew and play toy suitable for engaging an animal in play before and during consumption comprising:
co-extruding an edible composition; and
forming the edible composition into a helical shape.

15. The method of claim 14 wherein a ratio of an internal diameter of the helical shape to an external diameter of the helical shape ranges from 1:2 to 1:14.

16. The method of claim 14 wherein a ratio of an external diameter of the helical shape to a diameter of the edible composition ranges from 1:2.5 to 1:28.

17. The method of claim 14 wherein a ratio of an external diameter of the helical shape to a pitch of the helical shape ranges from 1:1 to 1:10.

18. The method of claim 14 wherein a ratio of an internal diameter of the helical shape to a pitch of the helical shape ranges from 1:1.75 to 1:20.

19. The method of claim 14 wherein a ratio of a diameter of the edible composition to an internal diameter of the helical shape ranges from 1:0.5 to 1:10.

20. The method of claim 14 wherein the helical shape has a pitch ranging from about 0.01 to about 1 inch.

21. The method of claim 14 wherein the helical shape has an overall length ranging from about 1 to about 20 inches.

22. The method of claim 14 comprising co-extruding a filling inside the edible composition.

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)
